(19) United States
(12) Patent Application Publication
(10) Pub. No.: US 2013/0342448 A1
(43) Pub. Date: Dec. 26, 2013

(54) INFORMATION PROCESSING APPARATUS, INFORMATION PROCESSING METHOD, AND PROGRAM PRODUCT

(71) Applicant: Kabushiki Kaisha Toshiba, Tokyo (JP)

(72) Inventors: Yasuyuki TANAKA, Akishima-shi (JP); Akira TANAKA, Mitaka-shi (JP); Ryuji SAKAI, Hanno-shi (JP); Kosuke HARUKI, Tachikawa-shi (JP); Mitsuru SHIMBAYASHI, Nakano-ku (JP); Takahiro SUZUKI, Hamura-shi (JP)

(73) Assignee: Kabushiki Kaisha Toshiba, Tokyo (JP)

(21) Appl. No.: 13/975,011

(22) Filed: Aug. 23, 2013

Related U.S. Application Data
(63) Continuation of application No. PCT/JP2013/058197, filed on Mar. 14, 2013.

(30) Foreign Application Priority Data
May 23, 2012 (JP) 2012-117939

(51) Int. Cl. G06F 3/01

(52) U.S. Cl. CPC G06F 3/012
USPC 345/156

(57) ABSTRACT

According to one embodiment, an information processing apparatus includes: a detector configured to set a detection area curved in an arc shape to a frame image included in a video that is based on input video data, with reference to a position of a face image included in the video to detect a movement of an operator giving an operation instruction in the detection area; and an output module configured to output operation data indicating the operation instruction given by the movement detected by the detector.

### CROSS-REFERENCE TO RELATED APPLICATIONS

This application is a continuation of PCT international application Ser. No. PCT/JP2013/058197, filed Mar. 14, 2013, which designates the United States, incorporated herein by reference, and which is based upon and claims the benefit of priority from Japanese Patent Application No. 2012-117939, filed May 23, 2012, the entire contents of which are incorporated herein by reference.

### FIELD

Embodiments described herein relate generally to an information processing apparatus, an information processing method, and a program product.

### BACKGROUND

Known is an information processing apparatus that detects an operator movement for an operation instruction from a video that is based on video data captured by an image capturing apparatus, and outputs operation data indicating the operation instruction given by the movement thus detected to a target apparatus.

However, according to the conventional technology, the operator cannot recognize the area where his/her movement giving an operation instruction is detected in the video that is based on the video data captured by the image capturing apparatus. Therefore, an operator movement other than an operation instruction might be detected as an operator movement giving an operation instruction, and the accuracy at which the target apparatus is caused to operate via a gesture is low. Furthermore, in the conventional technology, because the area in which an operator operation instruction is detected in a video based on video data captured by an image capturing apparatus does not have a shape that allows an operator to move hands easily when the operator makes an operation instruction, operability of the target apparatus using gestures is low.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external view of a computer according to an embodiment;

FIG. 2 is an exemplary block diagram generally illustrating a configuration of the computer in the embodiment;

FIG. 3 is an exemplary block diagram illustrating a part of a functional configuration of the computer in the embodiment;

FIG. 4 is an exemplary flowchart illustrating a process of outputting operation data in the computer in the embodiment;

FIG. 5 is an exemplary schematic diagram for explaining a process of setting a detection area in the computer in the embodiment;

FIG. 6 is an exemplary schematic diagram for explaining the process of setting a detection area in the computer in the embodiment;

FIG. 7 is an exemplary schematic diagram for explaining the process of setting a detection area in the computer in the embodiment;

FIG. 8 is an exemplary schematic diagram for illustrating a process of setting a detection area curved in an arc shape in the computer in the embodiment;

FIG. 9 is an exemplary schematic diagram for illustrating the process of setting a detection area curved in an arc shape in the computer in the embodiment;

FIG. 10 is an exemplary schematic diagram for illustrating the process of setting a detection area curved in an arc shape in the computer in the embodiment;

FIG. 11 is an exemplary schematic diagram for explaining a process of detecting a movement of an operation instruction in the computer in the embodiment;

FIG. 12 is an exemplary schematic diagram for explaining the process of detecting a movement of an operation instruction in the computer in the embodiment;

FIG. 13 is an exemplary schematic diagram for explaining the process of detecting a movement of an operation instruction in the computer in the embodiment;

FIGS. 14A to 14D are exemplary schematic diagrams for explaining a process of outputting operation data in the computer in the embodiment; and

FIGS. 15A to 15D are exemplary schematic diagrams for explaining the process of outputting operation data in the computer in the embodiment.

### DETAILED DESCRIPTION

In general, according to one embodiment, an information processing apparatus comprises: a detector configured to set a detection area curved in an arc shape to a frame image included in a video that is based on input video data, with reference to a position of a face image included in the video to detect a movement of an operator giving an operation instruction in the detection area; and an output module configured to output operation data indicating the operation instruction given by the movement detected by the detector.

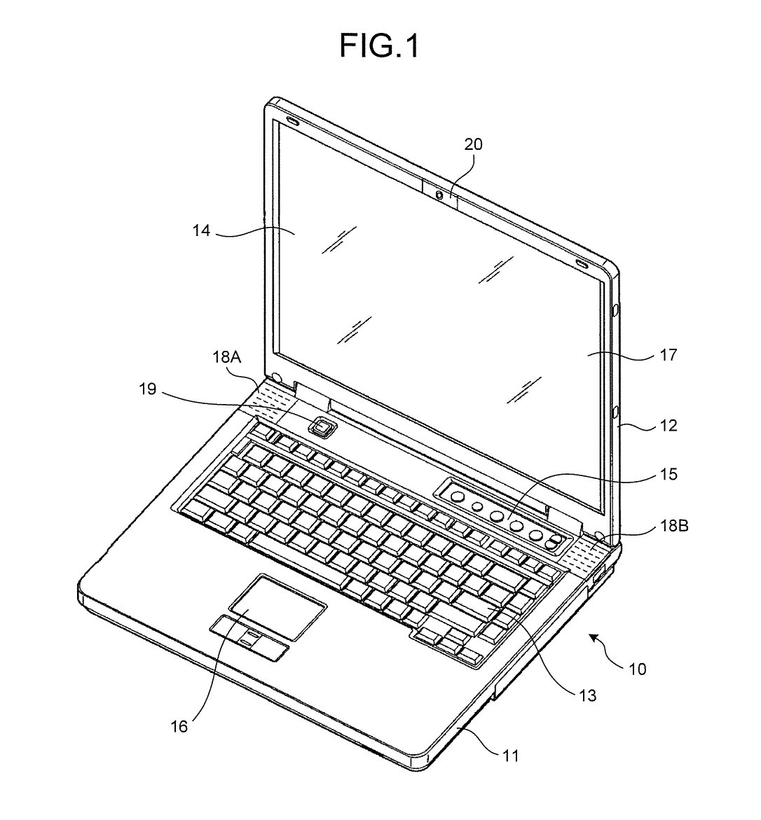

FIG. 1 is an external view of a computer according to an embodiment. Explained in the embodiment is an example in which an information processing apparatus, an information processing method, and a computer program are applied to a laptop personal computer (hereinafter referred to as a computer) 10, but the embodiment is not limited thereto, and is also applicable to a remote controller, a television receiver, a hard disk recorder, or the like. As illustrated in FIG. 1, the computer 10 according to the embodiment comprises a main unit 11 and a display unit 12. The display unit 12 is provided with a display device with a liquid crystal display (LCD) 17. The display unit 12 is also provided with a touch panel 14 covering the surface of the LCD 17. The display unit 12 is attached to the main unit 11 movably between an opened position exposing the top surface of the main unit 11 and a closed position covering the top surface of the main unit 11. The display unit 12 comprises a camera module 20 located at the top of the LCD 17. The camera module 20 is used to capture the image of an operator or the like of the computer 10 when the display unit 12 is at the opened position where the top surface of the main unit 11 is exposed.

The main unit 11 comprises a housing in a shape of a thin box. On the top surface of the main unit 11, a keyboard 13, an input operation panel 15, a touch pad 16, speakers 18A and 18B, and a power button 19 for powering on and off the computer 10, and the like are provided. On the input operation panel 15, various operation buttons are provided.

On the rear surface of the main unit 11, a terminal for connecting an external display (not illustrated), such as a terminal based on the High-Definition Multimedia Interface (HDMI) standard, is provided. The terminal for connecting an external display is used to output a digital video signal to the external display.

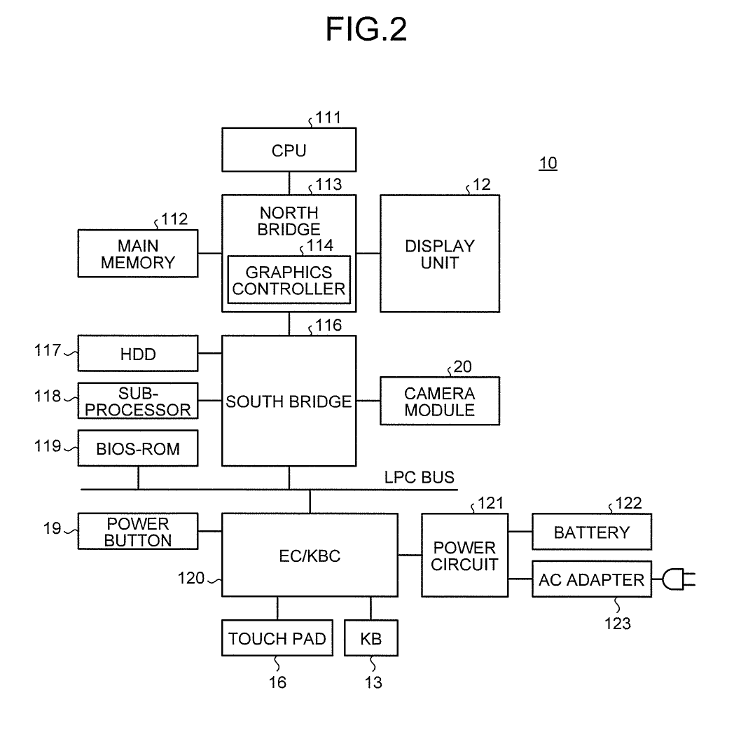

FIG. 2 is a block diagram generally illustrating a configuration of the computer in the embodiment. The computer 10 according to the embodiment comprises a central processing unit (CPU) 111, a main memory 112, a north bridge 113, a graphics controller 114, the display unit 12, a south bridge 116, a hard disk drive (HDD) 117, a sub-processor 118, a basic input/output system read-only memory (BIOS-ROM) 119, an embedded controller/keyboard controller (EC/KBC) 120, a power circuit 121, a battery 122, an alternating current (AC) adapter 123, the touch pad 16, the keyboard (KB) 13, the camera module 20, and the power button 19.

The CPU 111 is a processor for controlling operations of the computer 10. The CPU 111 executes an operating system (OS) and various types of application programs loaded onto the main memory 112 from the HDD 117. The CPU 111 also executes a basic input/output system (BIOS) stored in the BIOS-ROM 119. The BIOS is a computer program for controlling peripheral devices. The BIOS is executed to begin with when the computer 10 is powered on.

The north bridge 113 is a bridge device for connecting a local bus of the CPU 111 and the south bridge 116. The north bridge 113 has a function of communicating with the graphics controller 114 via an accelerated graphics port (AGP) bus or the like.

The graphics controller 114 is a display controller for controlling the display unit 12 of the computer 10. The graphics controller 114 generates video signals to be output to the display unit 12 from image data written by the OS or an application program to a video random access memory (VRAM) (not illustrated).

The HDD 117, the sub-processor 118, the BIOS-ROM 119, the camera module 20, and the EC/KBC 120 are connected to the south bridge 116. The south bridge 116 comprises an integrated drive electronics (IDE) controller for controlling the HDD 117 and the sub-processor 118.

The EC/KBC 120 is a single-chip microcomputer in which an embedded controller (EC) for managing power and a keyboard controller (KBC) for controlling the touch pad 16 and the KB 13 are integrated. The EC/KBC 120 works with the power circuit 121 to power on the computer 10 when the power button 19 is operated, for example. When an external power is supplied via the AC adapter 123, the computer 10 is powered by the external power. When no external power is supplied, the computer 10 is powered by the battery 122.

The camera module 20 is a universal serial bus (USB) camera, for example. The USE connector on the camera module 20 is connected to an USB port (not illustrated) provided on the main unit 11 of the computer 10. Video data (image data) captured by the camera module 20 is stored in the main memory 112 or the like as frame data, and can be displayed on the display unit 12. The frame rate of frame images included in the video data captured by the camera module 20 is 15 frames/second, for example. The camera module 20 may be an external camera, or may be a built-in camera in the computer 10.

The sub-processor 118 processes video data acquired from the camera module 20, for example.

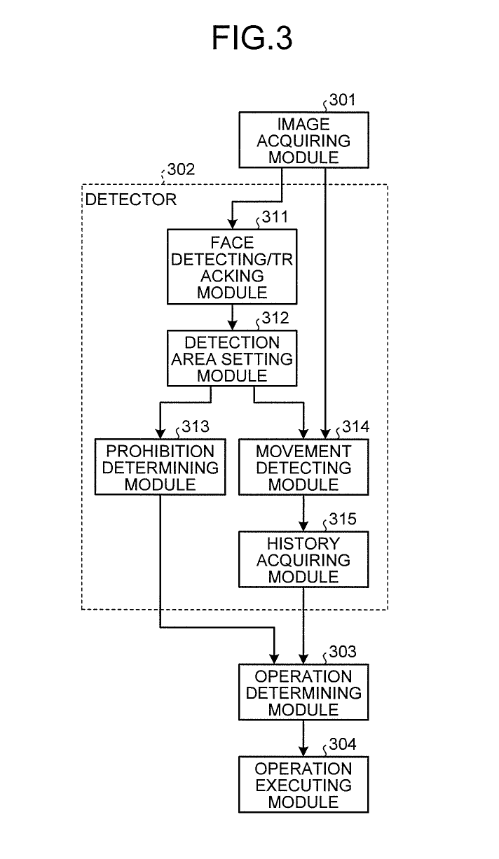

FIG. 3 is a block diagram illustrating a part of a functional configuration of the computer in the embodiment. The computer 10 according to the embodiment realizes an image acquiring module 301, a detector 302, an operation determining module 303, an operation executing module 304, and the like by causing the CPU 111 to execute the OS and the application programs stored in the main memory 112.

The image acquiring module 301 acquires video data captured by the camera module 20, and stores the video data in the HDD 117, for example.

The detector 302 sets a detection area to a frame image included in video that is based on the input video data (video data acquired by the image acquiring module 301) with reference to an image of a face included in the video, and detects a movement of an operator of the computer 10 giving an operation instruction from the detection area. In the embodiment, the detector 302 comprises a face detecting/tracking module 311, a detection area setting module 312, a prohibition determining module 313, a movement detecting module 314, and a history acquiring module 315.

The operation determining module 303 functions as an output module for outputting operation data indicating an operation instruction given by the movement detected by the detector 302. The operation executing module 304 controls a target apparatus (e.g., the display unit 12, the speakers 18A and 18B, or the external display) based on the operation data output from the operation determining module 303.

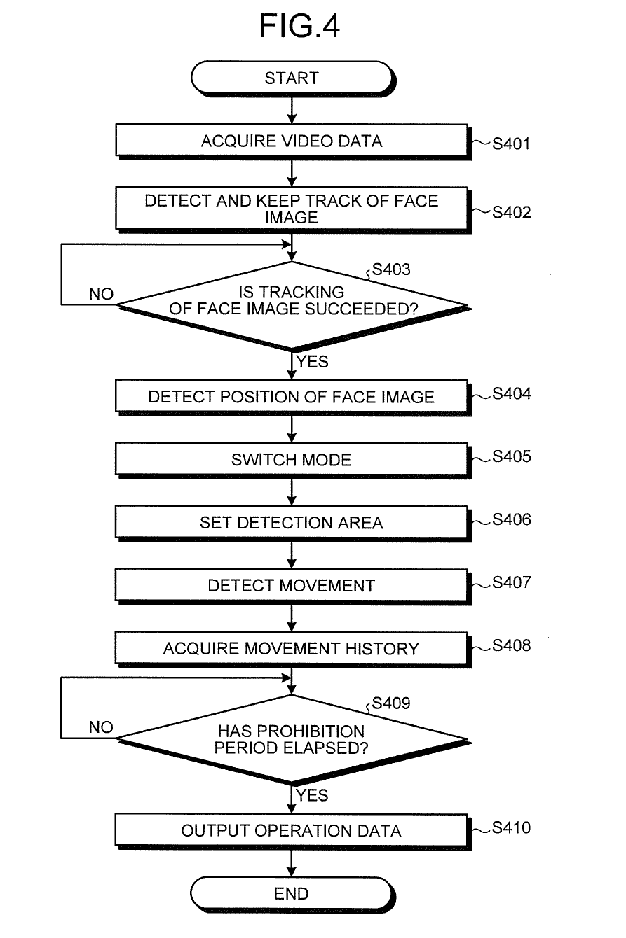

A process of outputting the operation data in the computer 10 according to the embodiment will now be explained with reference to FIGS. 4 to 14D. FIG. 4 is a flowchart illustrating a process of outputting operation data in the computer in the embodiment.

While the computer 10 is on after the power button 19 is operated, the image acquiring module 301 acquires video data captured by the camera module 20 (S401). In the embodiment, the image acquiring module 301 acquires video data by sampling a frame image at a preset sampling rate from frame images captured at a given frame rate by the camera module 20. In other words, the image acquiring module 301 keeps sampling frame images to acquire video data. The video data thus acquired may include a face image of an operator of the computer 10 (hereinafter referred to as a face image).

Once the image acquiring module 301 acquires the video data, the face detecting/tracking module 311 detects a face image from the video that is based on the video data thus acquired, and keeps track of the face image (S402). Keeping track of a keeping sampling frame images face image herein means to keep detecting a face image of the same operator across the frame images included in the acquired video data.

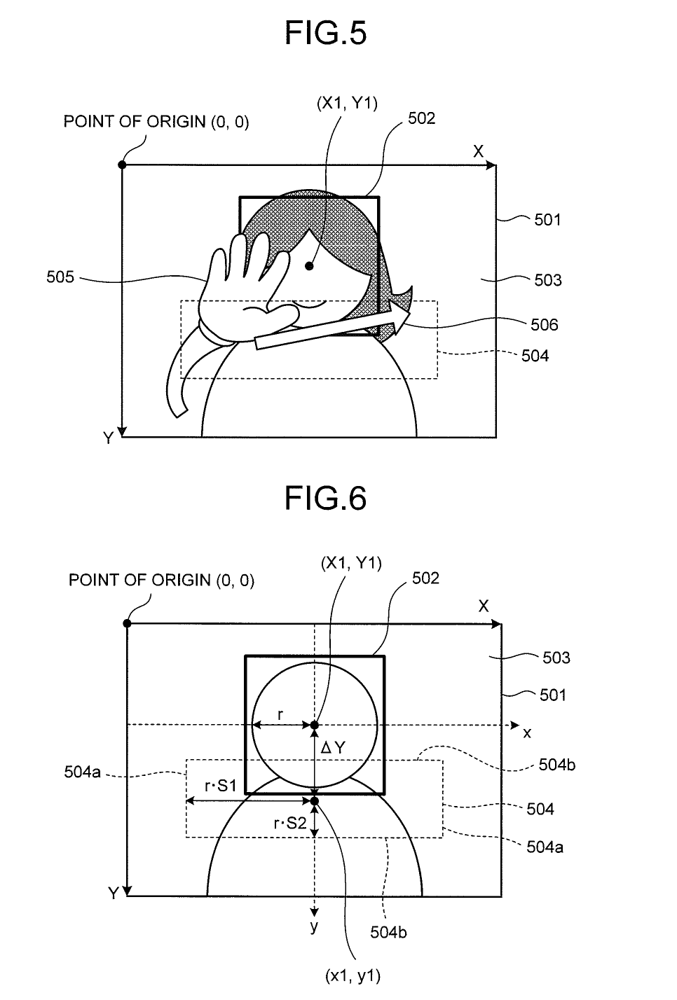

Specifically, the face detecting/tracking module 311 distinguishes a face image 502 from a non-face image 503 in a frame image 501 included in the video that is based on the acquired video data, using Scale-Invariant Feature Transform (SIFT), Speeded Up Robust Features (SURF), or the like, as illustrated in FIG. 5. In this manner, the face detecting/tracking module 311 detects the face image 502.

The face detecting/tracking module 311 then detects a plurality of characterizing points (e.g., three points of the nose, the left eye, and the right eye) from the face image 502 in the frame image 501 included in the video that is based on the acquired video data, using simultaneous localization and mapping (SLAM) (an example of parallel tracking and mapping (PTAM)) or the like that uses a tracking technique for keeping track of characterizing points, such as the Kanade Lucas Tomasi (KLT). At this time, the face detecting/tracking module 311 detects characterizing points that are the same as those in the face image 502 included in a frame image captured prior to the frame image 501, among the characterizing points in the face image 502 included in the frame image 501. In this manner, the face detecting/tracking module 311 keeps track of the detected face image 502.

The face detecting/tracking module 311 detects the face image 502 of a face directly facing the camera module 20, from the face images included in the frame image 501 included in the video that is based on the acquired video data. In the embodiment, the face detecting/tracking module 311 detects a face image including both eyes, or a face image not including ears as a face image 502 of a face directly facing the front, among the face images included in the frame image 501 included in the video that is based on the acquired video data. In other words, it can be assumed that, when an operator intends to make operations on the computer 10, the operator directly faces the display unit 12. Therefore, by detecting a face image 502 of a face directly facing the camera module 20, the face detecting/tracking module 311 can detect only the face image 502 of an operator intended to make operations on the computer 10. Because the subsequent process is triggered when an operator faces the display unit 12 directly, extra operations required for making an operation instruction via a gesture can be omitted.

Referring back to FIG. 4, the detection area setting module 312 determines if the face detecting/tracking module 311 succeeds in keeping track of the face image (S403). If the face detecting/tracking module 311 keeps track of the face image for given time (in the embodiment, equal to less than 1 second), the detection area setting module 312 determines that the face detecting/tracking module 311 succeeds in keeping track of the face image. If the face detecting/tracking module 311 fails to keep track of the face image (No at S403), the detection area setting module 312 waits until the face detecting/tracking module 311 succeeds in keeping track of a face image.

If the face detecting/tracking module 311 succeeds in keeping track of the face image (Yes at S403), the detection area setting module 312 detects the position of the face image included in the video that is based on the acquired video data (S404). In the embodiment, as the position of the face image 502, the detection area setting module 312 detects position coordinates (X1, Y1) of the center of the face image 502 detected by the face detecting/tracking module 311 (the position of the nose, in the embodiment) in a Cartesian coordinate system having a point of origin (0, 0) at the upper left corner of the frame image 501 included in the video data (hereinafter referred to as an XY coordinate system), as illustrated in FIG. 5. When a plurality of face images are included in the video based on the acquired video data, the detection area setting module 312 detects respective positions of the face images. If the position of the face image detected by the face detecting/tracking module 311 moves by a given distance or more within given time, the computer 10 stops the process of outputting the operation data. In this manner, when the operator loses his/her intention of making operations on the computer 10 and the position of the face image suddenly changes, e.g., when the operator stands up or lies down, the computer 10 can stop outputting the operation data.

The detection area setting module 312 detects an inclination of the axis extending in a vertical direction of the face image (hereinafter referred to as a face image axis) in the video that is based on the acquired video data. In the embodiment, the detection area setting module 312 detects an inclination of the face image axis (angle θ) in the XY coordinate system as an inclination of the face image. Specifically, the detection area setting module 312 considers an axis extending in the vertical direction of the face image and passing through the axis of symmetry making the face image symmetric as the face image axis, and detects the inclination of the face image axis in the XY coordinate system as an inclination of the face image. Alternatively, in a triangle connecting the nose, the left eye, and the right eye detected as characterizing points of the face image, the detection area setting module 312 may consider a perpendicular drawn from the characterizing point at the nose to a line segment connecting the characterizing point at the left eye and the characterizing point at the right eye as a face image axis, and detect the inclination of the face image axis in the XY coordinate system as an inclination of the face image.

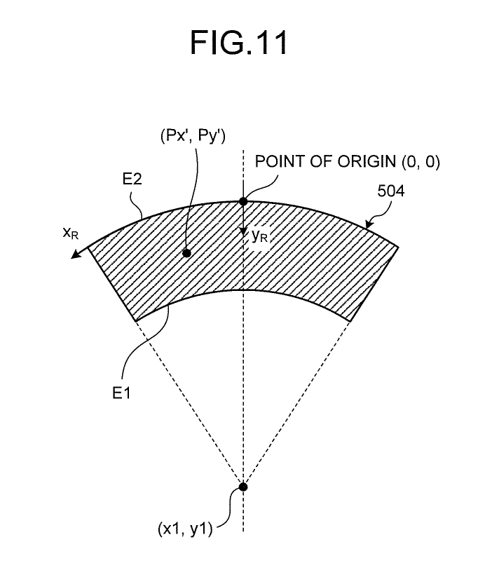

Referring back to FIG. 4, the detection area setting module 312 is switched to one of a first mode and a second mode depending on the image data displayed on the display unit 12 (S405). The first mode is for detecting an operator movement giving an operation instruction with reference to the XY coordinate system, and the second mode is for detecting an operator movement giving an operation instruction with reference to a Cartesian coordinate system using the face image axis as a coordinate axis (hereinafter referred to as an xy coordinate system) or a Cartesian coordinate system R (see FIG. 11). The xy coordinate system is a coordinate system in which the axis of the face image 502 is used as a y axis and an axis perpendicularly intersecting with the y axis at a predetermined position is used as an x axis. In the embodiment, the xy coordinate system is a coordinate system in which the axis of the face image 502 is used as a y axis and an axis perpendicularly intersecting with the y axis at the center of the face image 502 (position coordinates (X1, Y1)) is used as an x axis. The Cartesian coordinate system R (see FIG. 11) is a coordinate system in which, assuming that an area curved in an arc shape is set as the detection area for detecting an operator movement giving an operation instruction, an arc E2 (see FIG. 11) included in the detection area is used as an x_{R} axis (see FIG. 11), and an axis intersecting with the x_{R} axis at the center of the arc E2 is used as a y_{R} axis (see FIG. 11).

In the embodiment, if the image data displayed on the display unit 12 allows an operator to make an operation instruction more easily when the display unit 12 is used as a reference, e.g., in a case of a scrollable window, the detection area setting module 312 is switched to the first mode. If the image data displayed on the display unit 12 allows an operator to make an operation instruction more easily when the operator himself/herself is used as a reference, e.g., in a case of an interface related to selection of a channel number or the volume of sound output from the speakers 18A and 18B, the detection area setting module 312 is switched to the second mode.

The detection area setting module 312 then sets a detection area to a frame image included in the video with reference to the position of the detected face image (S406). The detection area herein means an area for detecting an operator movement (a movement of an operator's hand instructing an operation, or a movement of an object by an operation instruction) for instructing an operation (to scroll the content displayed in the window (e.g., a text, a picture, or an image), to select a channel number, or to change the volume, for example). When a plurality of face images are included in the video that is based on the acquired video data, the detection area setting module 312 sets a plurality of detection areas with reference to the positions of the respective face images.

In the embodiment, the detection area setting module 312 sets a detection area 504 for detecting a movement 506 of a hand 505 of an operator instructing an operation to the frame image 501 based on the position coordinates (X1, Y1) of the face image 502 and an inclination of the axis of the face image 502, as illustrated in FIG. 5. Specifically, the detection area setting module 312 sets the detection area 504 for detecting the movement 506 of the hand 505 of an operator instructing an operation to an area located below the position coordinates (X1, Y1) of the face image 502 in a direction of the axis of the face image 502. In this manner, because the detection area 504 is set with reference to the position of the operator, the detection area 504 can be set at a position where the operator can understand easily. Furthermore, because complex information such as a process of informing the position of the detection area 504 does not need to be informed to the operator, the cost required in informing the position of the detection area 504 to the operator and a workload of the operator checking the position of the detection area 504 can be reduced.

More specifically, the detection area setting module 312 acquires position coordinates (x1, y1) that are the position coordinates (X1, Y1) of the face image 502 shifted downwardly (along the y axis direction) as a center of the detection area 504, in the xy coordinate system having a point of origin at the position coordinates (X1, Y1) of the face image 502, as illustrated in FIG. 6. In other words, when the face image 502 of the operator is not inclined (when the upper torso of the operator is upright) as illustrated in FIG. 6, the detection area setting module 312 acquires coordinates shifted from the position coordinates (X1, Y1) of the face image 502 by a predetermined amount (ΔX=0, ΔY) in the XY coordinate system as a center of the detection area 504. The detection area setting module 312 also detects the size r of the face image 502 (for example, a radius assuming that the face image 502 is a circle). The detection area setting module 312 then sets the detection area 504 as a rectangle area having two facing sides 504a each of which is separated from the position coordinates (x1, y1) by r·S1 in the x axis direction and extending in parallel with the y axis, and having two facing sides 504b each of which is separated from the position coordinates (x1, y1) by r·S2 in the y axis direction and extending in parallel with the x axis in the xy coordinate system. Where, S1 and S2 are predetermined constants for making the detection area 504 a rectangle area having a center at the position coordinates (x1, y1). In the embodiment, each of S1 and S2 remains a given value regardless who the operator operating the computer 10 is, but the embodiment is not limited thereto, and each of S1 and S2 may be changed for each operator of the computer 10.

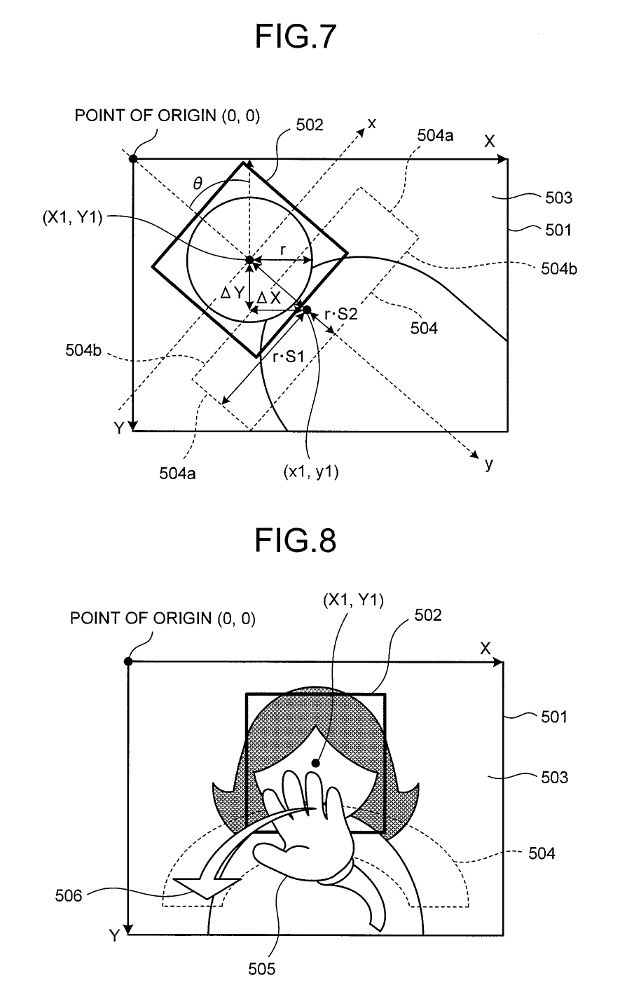

When the axis of the face image 502 is inclined by an angle θ in the XY coordinate system, e.g., when the operator of the computer 10 is lying, for example, the detection area setting module 312 sets the detection area 504 in the same manner. As illustrated in FIG. 7, the detection area setting module 312 acquires position coordinates (x1, y1) shifted downwardly from the position coordinates (X1, Y1) of the face image 502 (in the y axis direction) as a center of the detection area 504, in the xy coordinate system having the point of origin at the position coordinates (X1, Y1) of the face image 502 and inclined by the angle θ with respect to the XY coordinate system. In other words, when the face image 502 of the operator is inclined by an angle θ, as illustrated in FIG. 7, the detection area setting module 312 acquires coordinates shifted from the position coordinates (X1, Y1) of the face image 502 by a predetermined amount (ΔX, ΔY) for each angle θ in the XY coordinate system, as a center of the detection area 504. The detection area setting module 312 also detects the size r of the face image 502. The detection area setting module 312 then sets the rectangle area having two facing sides 504a each of which is separated from the position coordinates (x1, y1) by r·S1 in the x axis direction and extending in parallel with y axis, and having the two facing sides 504b each of which is separated from the position coordinates (x1, y1) by r·S2 in the y axis direction and extending in parallel with the x axis as the detection area 504. In the manner described above, when the face image 502 is inclined by an angle θ in the XY coordinate system, e.g., when the operator is lying, for example, the detection area 504 is set to a given area located below the face image 502 in the y axis direction in the xy coordinate system that is inclined by the angle θ with respect to the XY coordinate system. Therefore, even when the operator is lying, for example, the operator can make an operation instruction using the same gesture as when the upper torso of the operator is positioned upright.

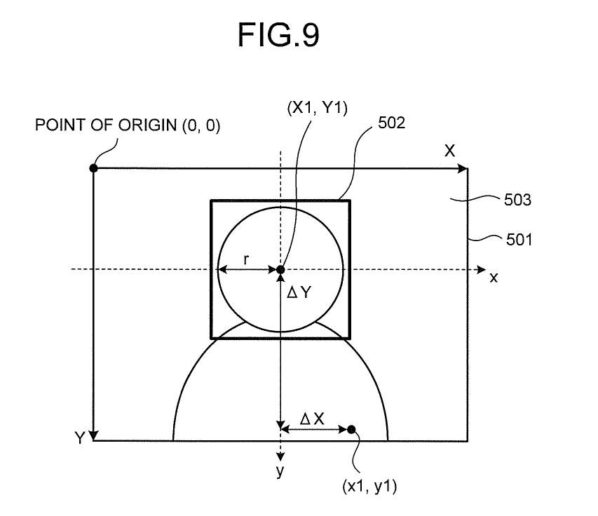

The detection area setting module 312 may also set a detection area in a manner curved in an arc shape to a frame image included in the video that is based on the acquired video data, with reference to the position of the face image included in the video. In the embodiment, the detection area setting module 312 sets the detection area 504 following an arc-like trajectory of an arm when the operator rotates his/her arm about the elbow, as illustrated in FIG. 8. Specifically, as illustrated in FIG. 9, when the operator rotates his/her arm about the elbow, the detection area setting module 312 acquires, as a center of the rotation, position coordinates (x1, y1) shifted downwardly (along the y axis direction) from the position coordinates (X1, Y1) of the face image 502 in the xy coordinate system having the point of origin at the position coordinates (X1, Y1) of the face image 502. More specifically, the detection area setting module 312 acquires the size r of the face image 502 to begin with. The detection area setting module 312 then acquires the position coordinates (x1, y1) as the center of the rotation in the xy coordinate system based on (x1, y1)=(X1+a·r·Δx, Y1+a·r·Δy). Where, a is a parameter used in acquiring the position coordinates (x1, y1). Δx is a parameter used in acquiring the x axis direction coordinate of the position coordinates (x1, y1). Δy is a parameter used in acquiring the y axis direction coordinate of the position coordinates (x1, y1). Through this process, the detection area setting module 312 acquires the coordinates shifted from the position coordinates (X1, Y1) of the face image 502 by a predetermined amount (ΔX, ΔY) in the XY coordinate system, as the center of the rotation.

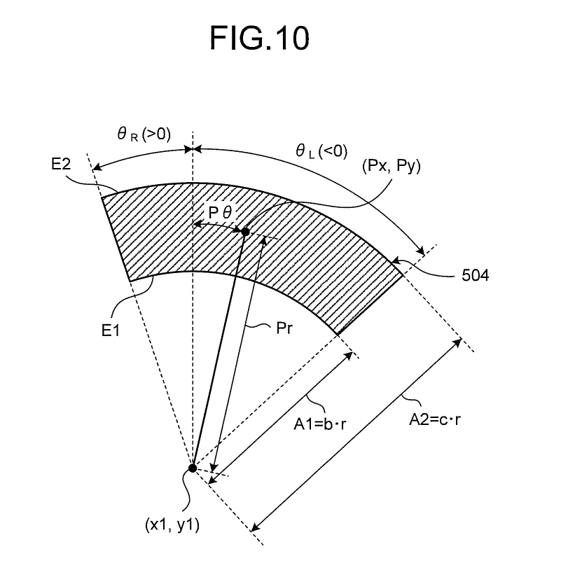

Once the position coordinates (x1, y1) of the center of the rotation are acquired, the detection area setting module 312 sets the detection area 504 in a fan shape (an area curved in an arc shape) having a center at the position coordinates (x1, y1). Specifically, the detection area setting module 312 sets the detection area 504 to an area between an arc E1 having a radius at the length of the arm (A1=b·r) and an arc E2 having a radius at the length from the elbow to the fingertip (A2=c·r), assuming that the arm is rotated by a predetermined angle θ′ (θ_{R}+|θ_{L}|) about the position coordinates (x1, y1), as illustrated in FIG. 10. Where, b and c are parameters used in acquiring the arcs E1 and E2. The parameters b and c may be changed depending on the operator of the computer 10. For example, the computer 10 stores therein parameters b and c in a manner associated with an operator identification (ID) of an operator who logs into the computer 10. When an operator logs into the computer 10, the detection area setting module 312 reads the parameters b and c stored in a manner associated with the operator ID of the operator who have logged in, and acquires the arcs E1 and E2 using the parameters b and c thus read.

In the embodiment, the detection area setting module 312 sets the detection area 504 to a fan-shaped area defined when the arm is rotated about the position coordinates (x1, y1) by a predetermined angle θ′ (θ_{R}+|θ_{L}|). However, the detection area setting module 312 may set the detection area 504 to a fan-shaped area (an area curved in an arc shape) defined in line symmetry with respect to an axis extending in the vertical direction of the face image 502 (y axis).

Referring back to FIG. 4, the movement detecting module 314 detects a movement in the detection area thus set (S407). When a plurality of detection areas are set by the detection area setting module 312, the movement detecting module 314 detects movements in the respective detection areas. In the embodiment, the movement detecting module 314 detects the movement 506 of the hand 505 in the detection area 504 in the frame image 501 included in the video that is based on the video data acquired by the image acquiring module 301, as illustrated in FIG. 5. The movement detecting module 314 also detects the movement 506 in the detection area 504 using the mode switched by the detection area setting module 312 (the first mode or the second mode).

Specifically, the movement detecting module 314 extracts frame images 501 between time t at which the last frame image is captured and time t−1 preceding the time t by given time (e.g., time corresponding to ten frames) from frame images 501 included in the video that is based on the acquired video data.

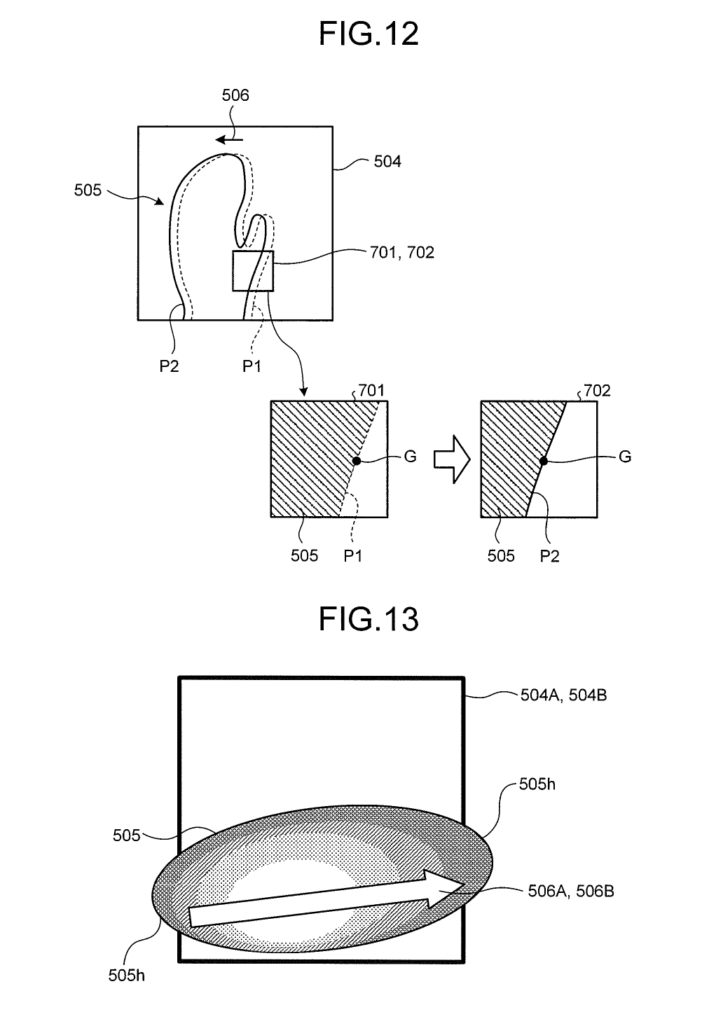

The movement detecting module 314 then detects the movement 506 of the hand 505 from the detection area 504 in each of the extracted frame images 501. In the example illustrated in FIG. 12, the hand 505 included in the detection area 504 moves from a position P1 illustrated in a dotted line to a position P2 illustrated in a solid line between the time t−1 and the time t. Specifically, the movement detecting module 314 extracts at least one partial image 701 including the hand 505 included in the detection area 504 at the time t, and at least one partial image 702 including the hand 505 included in the detection area 504 at the time t−1. The movement detecting module 314 then detects a movement of at least one pixel G included in the hand 505 in the respective partial images 701 and 702 between the time t and the time t−1 as a movement 506 of the hand 505. When the mode is switched to the first mode by the detection area setting module 312, the movement detecting module 314 detects the movement of the pixel G with reference to the XY coordinate system. When the mode is switched to the second mode by the detection area setting module 312, the movement detecting module 314 detects the movement of the pixel G with reference to the xy coordinate system.

In the embodiment, the movement detecting module 314 detects the movement 506 of the hand 505 in the example illustrated in FIG. 12. However, the embodiment is not limited thereto, provided that the movement detecting module 314 detects an operator movement giving an operation instruction. For example, the movement detecting module 314 may detect a movement of an object caused by an operation instruction given by an operator (e.g., an object held in a hand of the operator). Furthermore, when a plurality of detection areas are set by the detection area setting module 312, the movement detecting module 314 detects movements in the respective detection areas.

The movement detecting module 314 may also detect a movement 506 of a hand 505h near the detection area 504, in addition to a movement 506 of the hand 505 in the detection area 504, as illustrated in FIG. 13, provided that only the movement 506 detected in the detection area 504 is used in determining an operation instruction of the operator based on the movements 506 thus detected.

The movement detecting module 314 may detect only a movement 506 that can be detected reliably, without detecting a movement at a velocity higher than a predetermined velocity or a movement not intended to be an operation instruction (in the embodiment, a movement of the hand 505 along the X axis or the Y axis, or a movement other than a movement of the hand 505 along the x axis or the y axis), among the movements in the detection area 504, so that a movement of an operation instruction can be detected reliably.

When the detection area set by the detection area setting module 312 is an area curved in an arc shape, the movement detecting module 314 detects a movement represented in a polar coordinate system from the detection area, and converts the movement thus detected into a movement represented in a Cartesian coordinate system. Specifically, as illustrated in FIG. 10, the movement detecting module 314 converts the position coordinates (Px, Py) in the XY coordinate system into polar coordinates (Pr, Pθ) having a center at the position coordinates (x1, y1) in the polar coordinate system. Where, Pr is a square root of (Px−x1)²+(Py−y1)². Pθ is a a tan 2(y1−Py, x1−Px). If the polar coordinates (Pr, Pθ) satisfy A1<Pr<A2 and θ_{L}<Pθ<θ_{R}, the movement detecting module 314 determines that the polar coordinates (Pr, Pθ) are in the detection area 504.

If the polar coordinates (Pr, Pθ) are determined to be in the detection area 504, the movement detecting module 314 coverts a moving velocity (vᵣ, v_{θ}) of the polar coordinates (Pr, Pθ) between the frame images 501 into a moving velocity (vₓ, v_{y}) represented in the Cartesian coordinate system R. Specifically, the movement detecting module 314 converts the polar coordinates (Pr, Pθ) into position coordinates (Px′, Py′)=(2·A2·Pθ, A2−Pr) in the Cartesian coordinate system R in which the arc E2 is used as an x_{R} axis and an axis intersecting with the x_{R} axis at the center of the arc E2 (point of origin (0, 0)) is used as a y_{R} axis. The movement detecting module 314 then acquires the moving velocity (vₓ′, v_{y}′) of the position coordinates (Px′, Py′) as a movement in the detection area 504, based on the moving velocity (vᵣ, v_{θ}) of the polar coordinates (Pr, Pθ):

(vₓ′,v_{y}′)≅(d·vθ,evᵣ) (1)

Where, d and e are predetermined parameters used in acquiring a moving velocity (vₓ′, v_{y}′) from the moving velocity (vᵣ, v_{θ}) of the polar coordinates (Pr, Pθ).

$$( \begin{matrix}{V}_{θ} \\ {V}_{r}\end{matrix} ) = ( \begin{matrix}cos {P}_{θ} & - sin {P}_{θ} \\ sin {P}_{θ} & cos {P}_{θ}\end{matrix} ) ( \begin{matrix}{V}_{x} \\ - {V}_{y}\end{matrix} )$$

Where, vₓ and v_{y} are velocity vectors of the polar coordinates (Pr, Pθ) in the Cartesian coordinate system R.

Referring back to FIG. 4, the history acquiring module 315 acquires a history of movements represented in the Cartesian coordinate system and detected (or converted) by the movement detecting module 314 (S408).

The prohibition determining module 313 then determines if a prohibition period during which an operation instruction is prohibited has elapsed from when operation data is last output from the operation determining module 303 (S409). The prohibition period herein is a period during which an operator is prohibited from making any operation instruction, and may be set at discretion of an operator of the computer 10. If the prohibition period has not elapsed (No at S409), the prohibition determining module 313 waits until the prohibition period elapses. In this manner, when an operator makes an operation instruction and another operator makes an operation immediately after the first operator, the operation instruction made by the first operator is prevented from being cancelled by the operation instruction made by the second operator. Furthermore, when an operator makes an operation instruction using the same movement repeatedly (for example, when the operator repeatedly makes a movement of moving down the hand 505), as the hand 505 is brought back to the original position after moving down the hand 505, the movement of bringing back the hand 505 to the original position might be detected. In such a case, the prohibition period can prevent the movement of bringing down the hand 505 from being cancelled by the movement of bringing back the hand 505 to the original position.

The prohibition determining module 313 informs that an operation instruction can now be made after the prohibition period has elapsed. In the embodiment, when an operation instruction can be made, the prohibition determining module 313 notifies that an operation instruction can now be made by changing the display mode of the display unit 12, such as by displaying a message indicating that an operation instruction can now be made on the display unit 12. In the embodiment, the prohibition determining module 313 informs that an operation instruction can now be made by changing the display mode of the display unit 12, but the embodiment is not limited thereto, and the prohibition determining module 313 may also inform that an operation instruction can now be made using a light-emitting diode (LED) indicator not illustrated or the speakers 18A and 18B, for example.

When the prohibition determining module 313 determines that the prohibition period has elapsed (Yes at S409), the operation determining module 303 outputs operation data indicating an operation instruction given by a detected (converted) movement from the history of movement acquired by the history acquiring module 315 (S410). In the embodiment, the operation determining module 303 functions as an output module that outputs operation data indicating an operation instruction given by a movement thus acquired, when the movement acquired by the history acquiring module 315 is a movement in an up and down direction or a right and left direction in the XY coordinate system (or in the xy coordinate system).

In the embodiment, when a movement is detected in the rectangular detection area, the operation determining module 303 outputs operation data indicating an operation instruction given by the movement detected by the movement detecting module 314 (a movement represented in the XY coordinate system or the xy coordinate system). When a movement is detected in the curved detection area in an arc shape, the operation determining module 303 outputs operation data indicating an operation instruction given by the movement converted by the movement detecting module 314 (the movement represented in the Cartesian coordinate system R). In this manner, even when a movement detected by the movement detecting module 314 is a movement represented in the polar coordinate system, the operation determining module 303 can output operation data based on a movement represented in the Cartesian coordinate system R. Therefore, the operation data can be output following the same process as when a movement represented in the XY coordinate system or the xy coordinate system is detected.

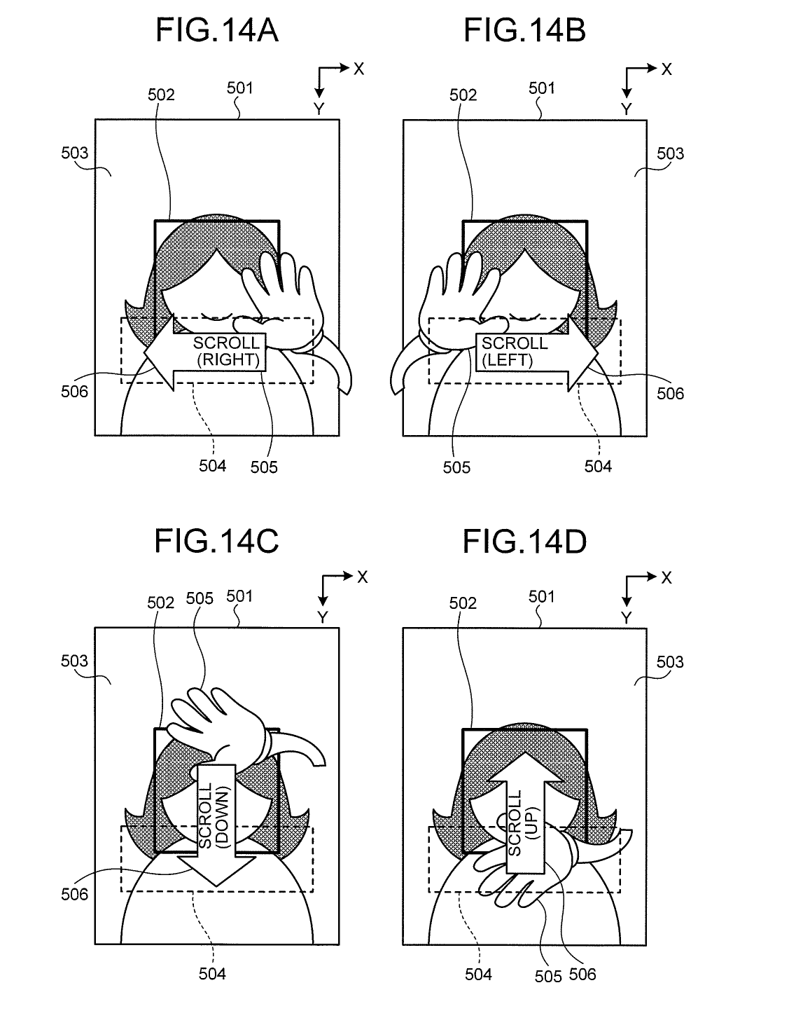

Specifically, when the detection area setting module 312 is switched to the first mode and the movement 506 acquired by the history acquiring module 315 is a movement from right to left in the detection area 504 (a movement from the positive side to the negative side approximately in parallel with the X axis in the XY coordinate system) as illustrated in FIG. 14A, the operation determining module 303 outputs operation data indicating an operation instruction for scrolling the image displayed in the window to the right on the display unit 12.

When the detection area setting module 312 is switched to the first mode and the movement 506 acquired by the history acquiring module 315 is a movement from left to right in the detection area 504 (a movement from the negative side to the positive side approximately in parallel with the X axis in the XY coordinate system) as illustrated in FIG. 14B, the operation determining module 303 outputs operation data indicating an operation instruction for scrolling the image displayed in the window to the left on the display unit 12.

When the detection area setting module 312 is switched to the first mode and the movement 506 acquired by the history acquiring module 315 is a movement from top to bottom in the detection area 504 (a movement from the negative side to the positive side approximately in parallel with the Y axis in the XY coordinate system) as illustrated in FIG. 14C, the operation determining module 303 outputs operation data indicating an operation instruction for scrolling down the image displayed in the window on the display unit 12.

When the detection area setting module 312 is switched to the first mode and the movement 506 acquired by the history acquiring module 315 is a movement from bottom to top in the detection area 504 (a movement from the positive side to the negative side approximately in parallel with the Y axis in the XY coordinate system), as illustrated in FIG. 14D, the operation determining module 303 outputs operation data indicating an operation instruction for scrolling up the image displayed in the window on the display unit 12.

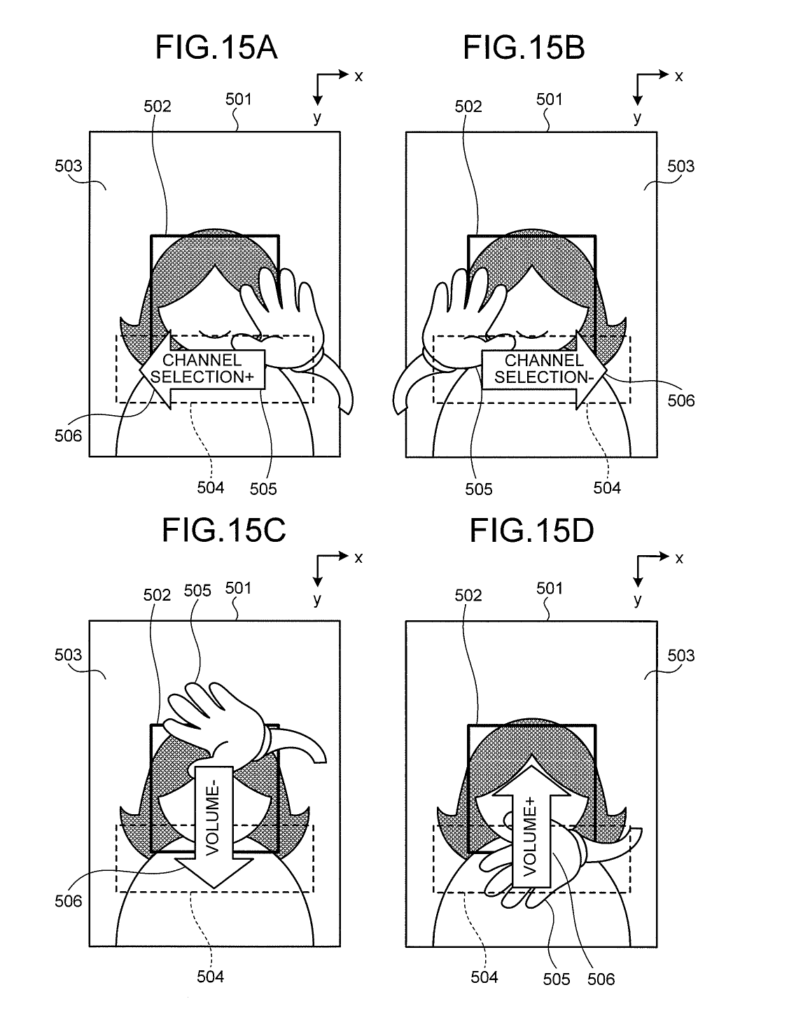

When the detection area setting module 312 is switched to the second mode and the movement 506 acquired by the history acquiring module 315 is a movement from right to left in the detection area 504 (a movement from the positive side to the negative side approximately in parallel with the x axis in the xy coordinate system, or a movement from the positive side to the negative side approximately in parallel with the x_{R} axis in the Cartesian coordinate system R) as illustrated in FIG. 15A, the operation determining module 303 outputs operation data indicating an operation instruction for increasing a channel number of broadcast data displayed on the display unit 12.

When the detection area setting module 312 is switched to the second mode and the movement 506 acquired by the history acquiring module 315 is a movement from left to right in the detection area 504 (a movement from the negative side to the positive side approximately in parallel with the x axis in the xy coordinate system, or a movement from the negative side to the positive side approximately in parallel with the x_{R} axis in the Cartesian coordinate system R) as illustrated in FIG. 153, the operation determining module 303 outputs operation data indicating an operation instruction for decreasing a channel number of broadcast data displayed on the display unit 12.

When the detection area setting module 312 is switched to the second mode and the movement 506 acquired by the history acquiring module 315 is a movement from top to bottom in the detection area 504 (a movement from the negative side to the positive side approximately in parallel with the y axis in the xy coordinate system, or a movement from the negative side to the positive side approximately in parallel with the y_{R} axis in the Cartesian coordinate system R) as illustrated in FIG. 15C, the operation determining module 303 outputs operation data indicating an operation instruction for reducing the volume of sound related to the broadcast data displayed on the display unit 12 and output from the speakers 18A and 183.

When the detection area setting module 312 is switched to the second mode and the movement 506 acquired by the history acquiring module 315 is a movement from bottom to top in the detection area 504 (a movement from the positive side to the negative side approximately in parallel with the y axis in the xy coordinate system, or a movement from the positive side to the negative side approximately in parallel with the y_{R} axis in the Cartesian coordinate system) as illustrated in FIG. 15D, the operation determining module 303 outputs operation data indicating an operation instruction for increasing the volume of sound related to the broadcast data displayed on the display unit 12 and output from the speakers 18A and 18B.

When the movement detecting module 314 detects movements in a plurality of detection areas, the operation determining module 303 outputs operation data based on the operation instruction given by the movements detected in the respective detection areas. For example, the operation determining module 303 accumulates the movements detected in the detection areas.

If the movements thus accumulated correspond to the same operation instruction, the operation determining module 303 outputs operation data indicating an operation instruction given the movements thus accumulated. For example, when movements corresponding to an operation instruction for increasing the channel number of broadcast data displayed on the display unit 12 are detected approximately simultaneously, the operation determining module 303 outputs operation data indicating an operation instruction for increasing the channel number of the broadcast data.

By contrast, if the movements thus accumulated correspond to operation instructions that cancel out each other, the operation determining module 303 refrains from outputting any operation data. For example, when a movement corresponding to an operation instruction for increasing the volume of the sound output from the speakers 18A and 18B and a movement corresponding to an operation instruction for reducing the volume of sound output from the speakers 18A and 18B are detected approximately simultaneously, the operation determining module 303 refrains from outputting any operation data.

Referring back to FIG. 4, once the operation determining module 303 outputs operation data, the operation executing module 304 controls the target apparatus (e.g., the display unit 12) based on the output operation data.

In the computer 10 that can display a plurality of windows on the display unit 12, the display unit 12 may display a window showing an image of a detection area superimposed over a video including the face image based on input video data, in addition to a window (image data) the operator is currently viewing. In this manner, by looking at the window showing a face image included in the video and the detection area, the operator of the computer 10 can easily understand where the operator should make an operation instruction to give an operation instruction.

In the manner described above, the computer 10 according to the embodiment sets a detection area curved in an arc shape to a frame image included in a video that is based on input video data with reference to the position of a face image included in the video, detects an operator movement giving an operation instruction from the detection area, and outputs operation data indicating an operation instruction given by the movement thus detected. Therefore, the detection area can be provided in a shape that enables an operator to move his/her hand easily in making an operation instruction. Hence, operability of a target apparatus via a gesture can be improved. Furthermore, because an operator can easily recognize the area for detecting an operator movement for giving an operation instruction, the accuracy of causing the computer 10 to operate via a gesture can be improved.

The computer program executed on the computer 10 according to the embodiment may be provided in a manner recorded in a computer-readable recording medium such as a compact disk read-only memory (CD-ROM), a flexible disk (FD), a compact disk recordable (CD-R), or a digital versatile disk (DVD) as a file in an installable or executable format.

Furthermore, the computer program executed on the computer 10 according to the embodiment may be stored in a computer connected to a network such as the Internet, and made available for download over the network. Furthermore, the computer program executed on the computer 10 according to the embodiment may be provided or distributed over a network such as the Internet.

Furthermore, the computer program according to the embodiment may be provided in a manner incorporated in a ROM or the like in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a detector configured to set a detection area curved in an arc shape to a frame image included in a video that is based on input video data, with reference to a position of a face image included in the video to detect a movement of an operator giving an operation instruction in the detection area; and
an output module configured to output operation data indicating the operation instruction given by the movement detected by the detector.

2. The information processing apparatus of claim 1, wherein the detection area is configured, when the operator rotates an arm about an elbow, to be set in a manner following an arc-like trajectory of the arm.

3. The information processing apparatus of claim 1, wherein
the detector is configured to detect the movement represented in a polar coordinate system from the detection area to convert the movement detected to the movement in a Cartesian coordinate system, and
the output module is configured to output the operation data indicating the operation instruction given by the movement represented in the Cartesian coordinate system, and to output the operation data indicating the operation instruction given by the movement converted.

4. The information processing apparatus of claim 1, wherein the detection area is configured to be set in line symmetry with respect to a line extending in a vertical direction of the face image.

5. An information processing method implemented by an information processing apparatus including a detector and an output module, the information processing method comprising:
setting, by the detector, a detection area curved in an arc shape to a frame image included in a video that is based on input video data, with reference to a position of a face image included in the video, and detecting, by the detector, a movement of an operator giving an operation instruction in the detection area; and
outputting, by the output module, operation data indicating the operation instruction given by the movement detected by the detector.

6. A computer program product having a non-transitory computer readable medium including programmed instructions, wherein the instructions, when executed by a computer, cause the computer to perform:
setting a detection area curved in an arc shape to a frame image included in a video that is based on input video data, with reference to a position of a face image included in the video to detect a movement of an operator giving an operation instruction in the detection area; and
outputting operation data indicating the operation instruction given by the movement detected by the detector.
